(19) United States
(12) Patent Application Publication
(10) Pub. No.: US 2026/0222334 A1
(43) Pub. Date: Jul. 30, 2026

(54) LATENCY-AWARE DISTRIBUTED SFC PLACEMENT IN A FEDERATED EDGE ENVIRONMENT

(71) Applicant: Dell Products L.P., Round Rock, TX (US)

(72) Inventors: Ana Cristina Bernardo de Oliveira, Rio de Janeiro (BR); Anselmo Luiz Eden Battisti, Niterói (BR); Debora Christina Muchaluat Saade, Rio de Janeiro (BR); Evandro Luiz Cardoso Macedo, Rio de Janeiro (BR); Flavia Coimbra Delicato, Niterói (BR); Juan Lucas do Rosario Vieira, Sao Goncalo (BR); Julia Drummond Noce, Rio de Janeiro (BR); Paulo de Figueiredo Pires, Niterói (BR)

(21) Appl. No.: 19/040,385

(22) Filed: Jan. 29, 2025

(51) Int. Cl. H04L 45/302; H04L 45/48

(52) U.S. Cl. CPC H04L 45/306; H04L 45/48

(57) ABSTRACT

Various embodiments relate to a method for managing Service Function Chain (SFC) requests in a federated edge computing system comprising multiple domains. The method involves receiving an SFC request at a first domain, which specifies a service provided by an ordered set of Virtual Network Functions (VNFs), each performing a specific service functionality. The method includes determining which VNFs are to be hosted by nodes in the first domain and which by nodes in a second domain. It further involves mapping segments, including VNFs and paths within the first domain, and paths to a first gateway node connecting to a second gateway node in the second domain, onto a segment solution tree. Each segment defines a potential placement plan for the VNFs. The segment solution tree is then provided to the second domain via the first gateway node, facilitating efficient service deployment across the federated system.

### TECHNOLOGICAL FIELD OF THE DISCLOSURE

Embodiments disclosed herein generally relate to federated edge computing systems. More particularly, at least some embodiments relate to systems, hardware, software, computer-readable media, and methods for the placement of a Service Function Chain (SFC) in federated edge computing systems.

### BACKGROUND

The fifth-generation mobile networks (5G) bring an evolution of network service provisioning through a new communication paradigm, which enables the development of new applications and improves users' experience. With 5G, it is envisioned that networks will provide services accessed by a variety of users, some of such services will have strict delay requirements. In such a context, Edge Computing and Network Function Virtualization (NFV) are promising technologies to deal with such demands by bringing computation closer to the user and replacing dedicated hardware implementations with software instances based on virtualization. One of the well-known challenges in the context of NFV is the resource allocation problem. In particular, the Service Function Chain (SFC) placement problem is considered a major challenge, even more, when the distributed placement in a multi-domain context is considered. While centralized approaches can be followed for this purpose, scalability and privacy concerns make the applicability of centralized solutions difficult.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1A-1H disclose aspects of generating a segment solution tree at a first domain.

FIGS. 2A-2D disclose aspects of updating the segment solution tree at a second domain.

FIG. 3 discloses aspects of a method according to one embodiment.

FIG. 4 discloses aspects of a method according to one embodiment.

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to federated edge computing systems. More particularly, at least some embodiments relate to systems, hardware, software, computer-readable media, and methods for the placement of Service Function Chains (SFC) in federated edge computing systems.

In some aspects, the embodiments described herein relate to a method, including: receiving at a first domain of a federated edge computing system including at least two or more separate domains a Service Function Chain (SFC) request, the SFC request defining a service which is provided by an ordered set of Virtual Network Functions (VNFs), each of which performs a specific functionality of the service; determining, based on the SFC request, which of the VNFs are to be hosted by nodes of the first domain and which of the VNFs that are to be hosted by nodes of a second domain of the federated edge computing system; mapping one or more segments that include the VNFs that are to be hosted by the nodes of the first domain, paths between the VNFs that are to be hosted by the nodes of the first domain, and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC; and providing via the first gateway node the segment solution tree to the second domain.

In some aspects, the embodiments described herein relate to a method, including: receiving at a second domain of a federated edge computing system including at least two or more separate domains a segment solution tree from a first domain of the federated edge computing system, the segment solution tree including one or more segments that include Virtual Network Functions (VNFs) of a Service Function Chain (SFC) that are to be hosted by nodes of the first domain, paths between the VNFs that are to be hosted by the nodes of the first domain, and paths to a first gateway node of the first domain that connects with a second gateway node of the second domain for VNFs that are to be hosted by nodes of the second domain, the VNFs each performing a specific functionality of the SFC; adding the VNFs that are to be hosted by the nodes of the second domain, paths between the VNFs that are to be hosted by the nodes of the second domain, and paths between the first and second gateways to the one or more segments; updating the segment solution tree with the additions to the one or more segments; and providing the updated segment solution tree to the first domain via the second gateway node so that the first domain can use the updated segment solution tree to select one of the one or more segments as a placement plan for the VNFs of the SFC.

In some aspects, the embodiments described herein relate to a non-transitory storage medium having stored therein instructions that are executable by one or more hardware processors to perform operations including: receiving at a first domain of a federated edge computing system including at least two or more separate domains a Service Function Chain (SFC) request, the SFC request defining a service which is provided by an ordered set of Virtual Network Functions (VNFs), each of which performs a specific functionality of the service; determining, based on the SFC request, which of the VNFs are to be hosted by nodes of the first domain and which of the VNFs that are to be hosted by nodes of a second domain of the federated edge computing system; mapping one or more segments that include paths between the VNFs that are to be hosted by the nodes of the first domain and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC; and providing via the gateway node the segment solution tree to the second domain.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Network Function Virtualization (NFV) technology allows for the implementation of software-based functions on commodity hardware. When combined with edge computing, which brings computational power closer to the user, both paradigms enable providing delay-stringent services in a cost-effective manner when compared to a hardware-based network function deployment. In this context, services are provided as an ordered set of Virtual Network Functions (VNFs), each performing a specific functionality required in the service, composing a Service Function Chain (SFC). An SFC definition, besides describing the ordered set of required VNFs, also encompasses the service requirements in terms of resources, QoS parameters, and constraints related to the service provision.

VNF resource allocation consists of finding appropriate computing nodes to host VNFs such that service requirements are fulfilled. As different infrastructure providers offer their resources to service providers, the underlying infrastructure where the VNFs are to be deployed might be organized under different administrative domains. Limiting the SFC deployment to a single domain might lead to higher blocking rates due to resource scarcity within a single domain compared to the number of services that must be provided. Therefore, exploring a multi-domain approach in SFC placement allows for better scalability, since a higher number of computing resources is available for the deployment of VNFs. Additionally, a multi-domain placement approach can help reduce SFC deployment costs for the service providers. Since the demanded resources might be offered by different infrastructure providers, each defining their own costs based on different criteria, the resources heterogeneity offered by the multi-domain environment can be explored to find candidate nodes to host the VNFs of the SFC in a more cost-effective manner.

In a multi-domain environment, a centralized approach can be used to reduce the complexity in deciding where to deploy the VNFs. However, in this strategy all domains must share information regarding their resource availability to a central entity, which might not be desirable for privacy reasons. Also, this approach might lack scalability in terms of the computational power and execution time to find a suitable placement plan, when a high number of nodes is available. On the other hand, a distributed approach allows subdividing the placement problem into multiple subproblems to be solved by each domain. Decisions on parts of the problem can produce SFC segments, which is parts of the SFC, which can be later combined to find an appropriate placement plan according to some criteria, such as cost or delay reduction. Yet, achieving such cooperation between different domains in a distributed manner can be a complex task, due to the heterogeneity of each domain and the lack of a global view of resources in the multi-domain infrastructure.

### B. Context

The SFC placement problem consists of selecting appropriate edge nodes to deploy the required VNFs that, together, perform the necessary functionalities to provide an SFC. These nodes must be selected taking into account the specific characteristics of nodes and links, and the Quality of Service (QoS) requirements described at a Service Level Agreement (SLA). However, resource utilization must be optimized to avoid waste of resources and increased operation costs. Therefore, the complexity of the SFC placement problem in edge nodes derives from the fulfilling multiple and often conflicting restrictions in a highly heterogeneous and dynamic environment.

Placing SFCs in a multi-domain environment imposes extra complexity to the SFC placement problem. Domains must cooperate with each other to share their pool of resources and provide the requested services jointly. Besides the characteristics of each domain in terms of node and link resources, privacy, scalability and attendance to domain-specific policies are concerns that must be considered when deciding which domain will be responsible for deploying one or multiple VNFs that will compose the service.

Thus, the SFC placement problem has at least the following two major challenges:
1. To place SFCs in a distributed and heterogeneous environment, which requires a decentralized placement solution
2. To place SFCs in environments that involve multiple administrative domains.

Each of these challenges will now be discussed in more detail in following sections.

### B.1 Placing SFCs In A Distributed And Heterogeneous Environment

Since an SFC is as a set of ordered VNFs, the problem of SFC placement shares many similarities with the resource allocation problem in NFV environments. When choosing the nodes that will execute the VNFs, the resource capacity of each node must be taken into account to ensure that the node can properly execute the assigned VNF. At the same time, resource utilization must be kept to a minimum at the underlying edge infrastructure to increase the quantity of requests that can be fulfilled by the service provider and to reduce costs and energy consumption.

When multiple domains are involved, new challenges in the SFC placement problem arise. First, the number of available nodes in a multi-domain environment tend to be significantly higher when compared to a single domain infrastructure. A centralized approach can be used considering the infrastructure of each domain as a single, larger, infrastructure. However, this would require a global view of the resources, which might not be available, or it might be very costly to obtain, and a placement approach capable of handling a high number of nodes. Therefore, due to these scalability concerns, a distributed approach, where the problem can be divided in smaller parts to be solved by each domain, is more suitable. However, distributed SFC placement is a complex task, since each entity that is part of the distributed process will take individual decisions that have to converge to a feasible placement plan that satisfies service requirements specified in an SLA.

Also, additional challenges arise in this scenario. In a multi-domain scenario, communication over the Internet can make it difficult to meet delay constraints, and the SFC placement solutions need to consider the high delay of inter-domain links. In addition, the links that connect different domains may have different costs, and some specificities need to be considered in the SFC placement solution in order to find the optimal placement strategy.

### B.2 SFC Placement Between Independent Service Providers From Multiple Administrative Domains

In a multi-domain environment, each domain has its own infrastructure composed of computing nodes, gateways and links. When sharing resources with other domains to create an edge federation, a domain might have its own policies and preferences on how to utilize its resources. Therefore, a multi-domain distributed SFC approach must consider the specific characteristics and policies of each domain when choosing where to deploy the VNFs, which arise additional challenges to an already complex problem.

Due to privacy concerns, domains might not want to expose their internal information, such as the number of nodes/links available, and their resource capacities. Thus, it is desirable that a distributed SFC placement approach shares between domains only the information strictly required to reach a correct placement solution. At the same time, if more information is provided, the chances of achieving a feasible placement solution is increased. Therefore, it is desirable to have a good balance between the capacity of finding appropriate solutions and privacy-preserving when proposing a distributed placement solution. Another concern is related to the autonomy of each domain. Despite willing to collaborate to achieve a placement solution, domains might have their own policies related to how their resources should be utilized. Thus, proposing a SFC placement method for a multi-domain scenario that respects domain privacy and autonomy is a challenging task.

### C. Detailed Discussion Of Aspects Of An Embodiment

The embodiments disclosed herein provide at least a multi-domain approach to tackle the SFC placement problem in distributed scenarios and a privacy-preserving way to decide which domain will be responsible for placing each part of a requested SFC.

### C.1 System Model and Notations

The embodiments disclosed herein consider that multiple administrative domains, represented by the set D={d₁, d₂, . . . , dₙ}, can provide the resources required to deploy and run services. The embodiments consider that the underlying network infrastructure of the edge federation is represented as a single graph G=(H, L) that describes the computational hosts of all domains and their interconnections, where hosts are represented as vertices and links represented as edges. The set H=(H¹∪H²∪ . . . ∪H^{d}) is composed of the union of the sets of hosts H^{d} available at each domain d. The notation

$${h}_{n}^{d}$$

represents the n-th host at the domain d that can execute Virtual Network Function (VNF) instances. Each host has a certain amount of resources represented by the set Rₕ={cₕ, mₕ}, where cₕ and mₕ are the total amount of CPU and memory resources respectively at the host.

Similarly to the hosts, the set L=(L¹∪ . . . ∪L^{d}∪L^{inter}) represents the links of the underlying infrastructure. A set

$${L}^{d} = \{ {l}_{1 , 2}^{d} , {l}_{1 , 2}^{d} , … , {l}_{n , m}^{d} \}$$

represents the links within a domain d, where

$${l}_{n , m}^{d}$$

is the link that connects the hosts

$${h}_{n}^{d} and {h}_{m}^{d}$$

in that domain. Since domains must also be interconnected to allow cooperation, the set L^{inter}={l_{1,2}, l_{1,2}, . . . , l_{d}_{ₙ}_{,d}_{ₘ}} is composed of the links that connect two domains, where l_{d}_{ₙ}_{,d}_{ₘ} is the inter-domain link that connects the domains dₙ and dₘ. A host is considered as a gateway node if it contains an inter-domain link that connects the current domain to a neighbor domain. The notation N_{d} represents the set of domains that are neighbors of a domain d—i.e., directly reachable through one of the gateway nodes and respective inter-domain link. Each link is considered to have a certain amount of bandwidth and an associated delay, denoted by bₗ and dₗ respectively.

The embodiments considers that users U={u₁, u₂, . . . , uₙ} might request SFCs at any time. An SFC request describes a set of ordered VNFs that must be placed on the underlying infrastructure to provide a service s. The SFC request also describes (i) a source node, (ii) a destination node, (iii) the user that requested the SFC, and (iv) a maximum allowable delay

$${d}_{s}^{max}$$

for the service s. Each VNF has a given type among the ones available, denoted by the set V={v₁, v₂, . . . , vₙ}. Each VNF type vₙ demands a certain amount of CPU and memory resources from the host, denoted by d(cᵥ_{ₙ}) and d(mᵥ_{ₙ}) respectively. Hosts also have a list of VNF images available, represented by the set IMₕ={vi₁, vi₂, . . . , vᵢₙ}, where viₙ is the image of the n-th VNF type. A host is also associated with a tier t∈T. If the host is located at the cloud, it will be considered as a cloud-tier node. Likewise, if the host is located on the edge, it will be considered as an edge-tier node. The tier of a host h is represented by the notation tier(h). A VNF might have restrictions regarding to which tier it can be placed. The notation tier_{restriction}(vᵢ) represents the tier restrictions of a VNF vᵢ. In other words, every host belonging to the tier restriction of a VNF is excluded as a candidate node to host the VNF. A MEC-host node can be used to place a VNF if the resource, VNF image and tier constraints are all satisfied. Regarding the placement plan, the notation Vₛ represents the ordered set of VNFs required by a service s, whereas the notation Pₛ represents a candidate path used to connect the source node, nodes that host each VNF of the SFC and the destination node of a service s. Finally, the notation C_{i,j} denotes the cost to host a VNF vᵢ in a host hⱼ.

TABLE 1
System model and notations.

| Notation | Description |
|---|---|
| D = {d₁, d₂, ... , dₙ} | Set of domains of the system. |
| G = (H, L) | Undirected graph of the physical network. |
| H = (H¹ ∪ H² ∪ ... ∪ H^{d}) | Set of hosts where the VNFs can be executed. |
| ${H}^{d} = \{ {h}_{1}^{d} , {h}_{2}^{d} , … , {h}_{n}^{d} \}$ | Set of nodes in domain d |
| ${h}_{i}^{d}$ | i-th host of a domain d |
| L = (L¹ ∪ ... ∪ L^{d} ∪ L^{inter}) | Set of virtual links |
| ${L}^{d} = \{ {l}_{1 , 2}^{d} , {l}_{1 , 2}^{d} , … , {l}_{n , m}^{d} \}$ | Set of intra-domain virtual links of domain d |
| ${l}_{n , m}^{d}$ | Link of a domain d that connects node n and m |
| L^{inter} = {l_{1,2}, l_{1,2}, ... , l_{dn,dm}} | Set of inter-domain virtual links |
| l_{d}_{_{n,}}_{d}_{ₘ} | Inter-domain link that connects domain dₙ and dₘ |
| U = {u₁, u₂, ... , uₙ} | All the users that requests SFCs. |
| Rₕ = {cₕ, mₕ} | Set of resources of the host h. |
| cₕ | Available CPU capacity of the host h. |
| mₕ | Available Memory capacity of the host h. |
| V = {v₁, v₂, ... , vₙ} | Set of VNF types available at the system |
| d_{c}(vₙ) | CPU demand of the VNF vₙ. |
| dₘ(vₙ) | Memory demand of the VNF vₙ. |
| IMₙ = {vi₁, vi₂, ... , viₙ} | List of VNF images available at the host h. |
| bₗ | Bandwidth of the link I. |
| dₗ | Delay of the link I. |
| N_{d} | Set of neighbor domains of d. |
| ${d}_{s}^{max}$ | Maximum allowed delay for a service s. |
| Pₛ | Set of links that form the path for a service s. |
| Vₛ | Required set of chained VNFs for a service s. |
| T = {edge, cloud} | Set of tiers |
| tier(h) ∈ T | Tier of a host h |
| tier_{restriction}(vᵢ) ∈ T | Restricted tier for a VNF i |
| C_{i,j} | Cost of hosting a VNF vᵢ in a host hⱼ |

### C.2 Federated Distributed System

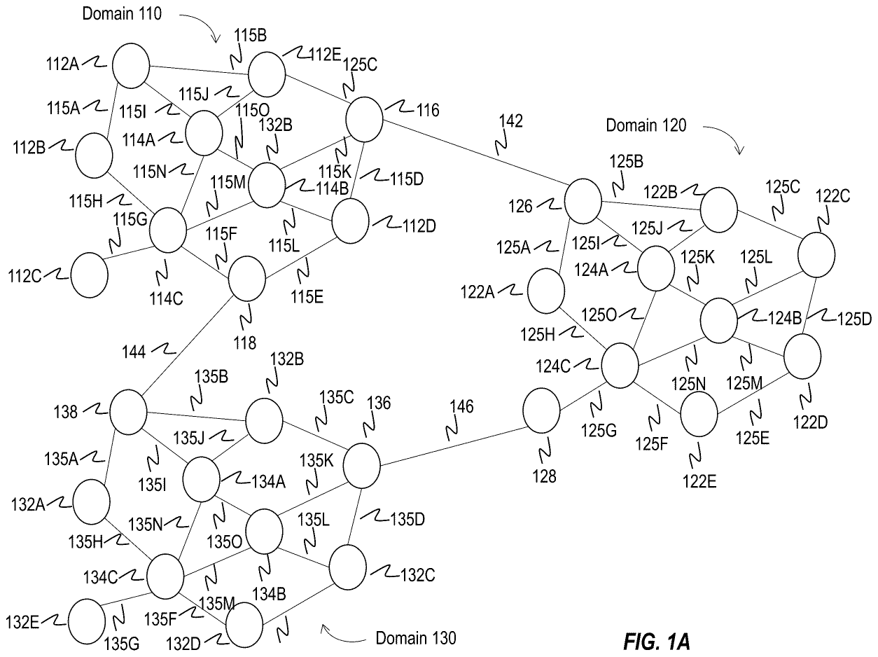

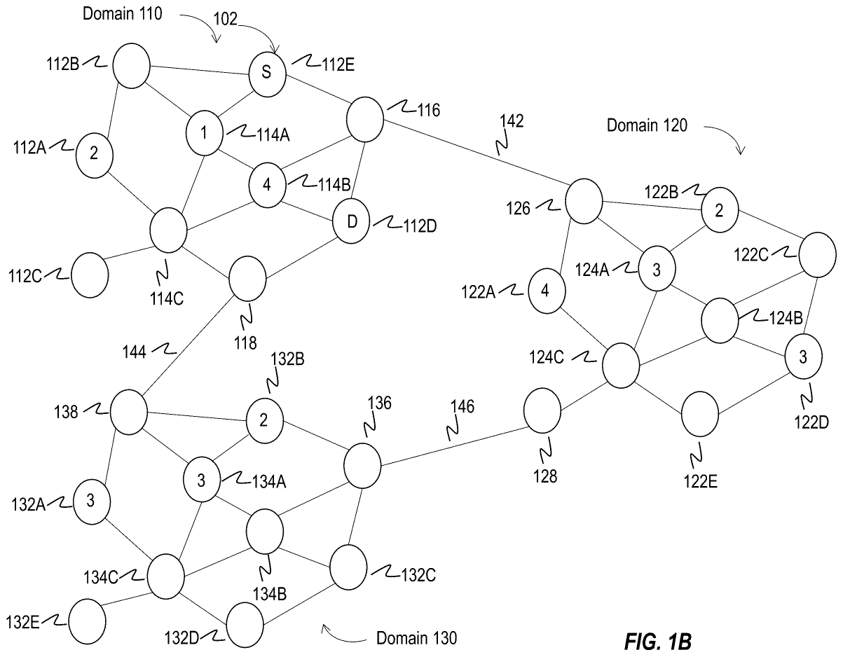

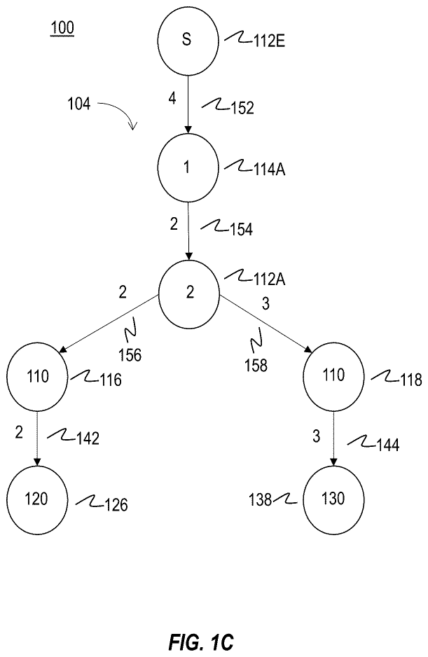

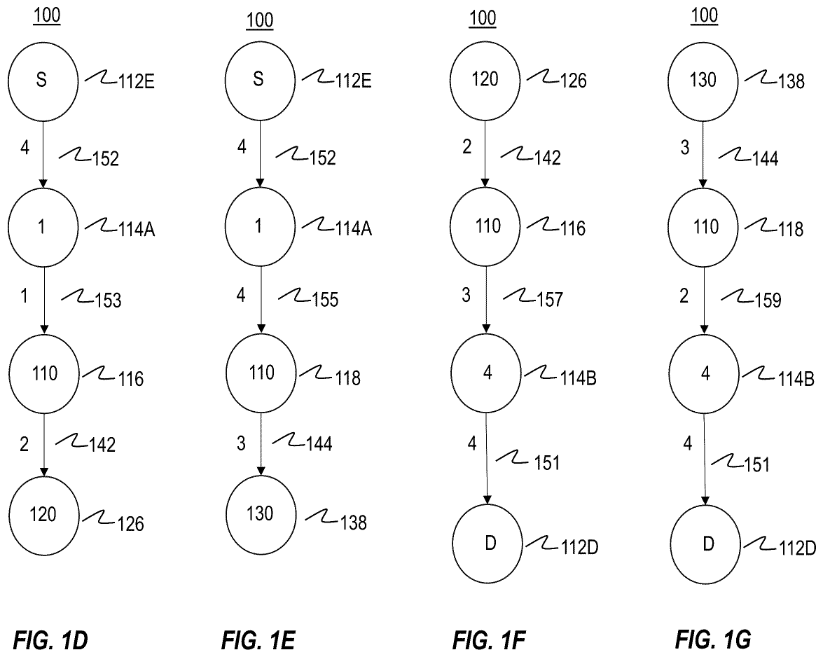

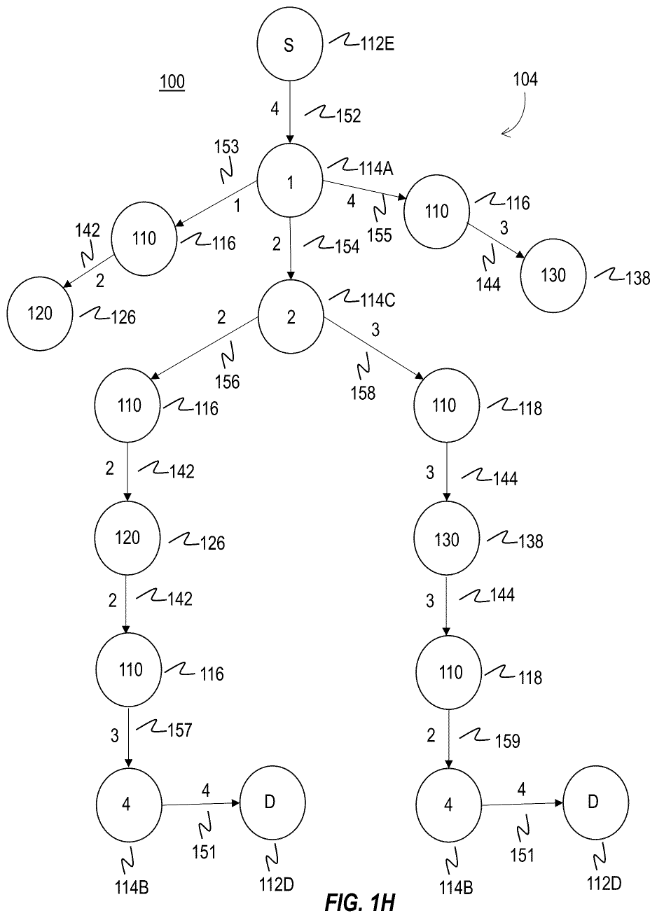

FIG. 1A illustrates an embodiment of a federated edge computing system 100 and it underlying infrastructure illustrated as a graph. As illustrated, the federated edge computing system 100 includes a set of domains that includes a domain 110, a domain 120, and a domain 130, although it will be appreciated that the federated edge computing system 100 can include any number of domains as circumstances warrant. The domains 110, 120, and 130 are systems of entities that are administratively separate from each other, for example separate telecom companies, which operate in a federated manner to implement a shared service via an SFC.

Accordingly, each of the domains 110, 120, and 130 include a set of nodes implemented on the hosts of each domain that are placed in a corresponding tier. In addition, each domain includes a set of intra-domain links that link each node in a domain and the federated distributed system includes a set of inter-domain links that link the domains to each other. Finally, each node (and the underlying hosts) has a certain amount of available resources disclosed in Table 1 such as CPU capacity and memory that can be used when implementing an SFC in the federated distributed system 100.

As illustrated in FIG. 1A, the domain 110 includes edge-tier nodes 112A, 112B, 112C, 112D, 112E, 116, and 118. The edge-tier nodes 116 and 118 also function as gateway nodes for linking with the other domains. The domain 110 also includes cloud-tier nodes 114A, 114B, and 114C. Intra-domain links 115A-1150 link the various edge-tier and cloud-tier nodes as illustrated in the figure.

As also illustrated in FIG. 1A, the domain 120 includes edge-tier nodes 122A, 122B, 122C, 122D, 122E, 126, and 128. The edge-tier nodes 126 and 128 also function as gateway nodes for linking with the other domains. The domain 120 also includes cloud-tier nodes 124A, 124B, and 124C. Intra-domain links 125A-1250 link the various edge-tier and cloud-tier nodes as illustrated in the figure.

As further illustrated in FIG. 1A, the domain 130 includes edge-tier nodes 132A, 132B, 132C, 132D, 132E, 136, and 138. The edge-tier nodes 136 and 138 also function as gateway nodes for linking with the other domains. The domain 130 also includes cloud-tier nodes 134A, 134B, and 134C. Intra-domain links 135A-1350 link the various edge-tier and cloud-tier nodes as illustrated in the figure.

As additionally illustrated in FIG. 1A, the gateway edge-tier node 116 of domain 110 links to gateway edge-tier node 126 of domain 120 via an inter-domain link 142 (also referred herein as “path 142”). The gateway edge-tier node 118 of domain 110 links to gateway edge-tier node 138 of domain 130 via an inter-domain link 144 (also referred herein as “path 144”). The gateway edge-tier node 128 of domain 120 links to gateway edge-tier node 136 of domain 130 via an inter-domain link 146.

### C.3 Federated Distributed SFC Segment Placement

The embodiments disclosed herein consider that an SFC segment is a contiguous part of an SFC that can be hosted within a single domain. The SFC segment may contain the source node, the destination node, mapped VNFs that are required by the SFC, gateway nodes, or links that form the path that connects the VNFs of the SFC. An SFC segment might also contain zero mapped VNFs if no available node in a domain can satisfy the placement constraints. In this case, the segment will contain only the necessary links to connect VNFs mapped in other available domains. Mapped VNFs in a segment are contiguous, following the order required by the SFC.

The segmentation of an SFC depends on the availability of resources in each domain. However, to ensure privacy among the various domains, the internal resource information of each domain is not to be shared with the other domains. Therefore, to evaluate which VNFs can be executed for each domain, the embodiments disclosed herein use a distributed approach in which each domain will find suitable nodes and links to form possible SFC segments, considering their individual capacities. The final SFC segmentation will depend on the decision-making of each domain, where one of the possible segmentations will be chosen. The union of SFC segments will comprise the SFC placement plan.

The segmentation decision making process starts with the domain that contains the source node from which the service packets (i.e., application workload) will arrive. The domain will execute the distributed federated segment placement to find appropriate nodes and links for the SFC segmentation. Then, it will propagate the solutions found to neighboring domains. Upon receiving the segmentation possibilities, each domain will look for partial placement solutions, based on its capabilities, building on the solution that was received by them.

A domain will first check to find internal candidate nodes that have the resources and ability to host the VNFs specified by the SFC. The domain will then find the longest contiguous segment of VNFs to which the domain can find suitable candidate nodes and links. These segments are compiled in a solutions tree that lists those different segment possibilities. A node in a solutions tree represents a real node and has a unique identifier, the owner (i.e., the domain that owns the node) and can have an assigned node type: source, destination, gateway or candidate node.

Candidate nodes have the information of the current VNF assigned to them, while gateway nodes have the domain that can be reached through them. Several nodes in a solutions tree might represent the same infrastructure node in a domain's infrastructure. Each node will have its own unique identifier that can only be mapped back to an infrastructure node by the domain that has added the node at the solutions tree (i.e., the domain must keep track of which nodes on a solutions tree represent which node in its infrastructure) to thereby ensure that the other domains do not learn the specific infrastructure implementation of each domain. The only exception is the solutions tree's gateway nodes, which also have the identification of the real infrastructure node to allow inter-domains connections when finding a solution. Each edge on the solutions tree represents a path chosen by a domain to connects two nodes, with an associated weight that represents the path delay. Similarly to nodes, each domain must keep track of which edge of the solutions tree represents which intra-domain path chosen during the placement process. The only exception is for edges that connect two gateway nodes in different domain, which represent a specific inter-domain link.

A segmentation plan can be derived from the solutions tree by traversing the path between the tree's root and a leaf node. If the root is the source node, all VNFs are mapped in the path in the correct other and the leaf node is the destination node, then the segmentation plan represents a complete feasible solution. After the execution of the placement, the domain will forward the solutions tree to each neighboring domain, which will also find possible segmentations based on the received solutions tree. The number of segments that compose a feasible placement solution will depend on how each domain can host the VNFs in its nodes. For example, a placement solution can be formed by single segment if a domain can map all VNFs of the SFC contiguously in its nodes, however, if the VNFs are mapped within two domains, then the solution will be formed by at least two segments, one found by each domain.

A feasible segmentation plan should satisfy all the service constraints specified in the SFC Request and its associated SLA. Candidate nodes to host a VNF should comply with the constraints defined below. Let x_{i,j} ∈{0,1} be a binary variable. The variable x_{i,j} is equals 1 if a VNF vᵢ is mapped to a node hⱼ and 0 otherwise.

Equations 1 and 2 define the CPU and memory resource constraints respectively. Considering all VNFs mapped to a node, the sum of the CPU demands of each VNF cannot exceed the amount of available CPU resources of a host. Likewise, the memory demands cannot exceed the available memory.

$${\sum }_{i ϵ {V}_{s} , j ϵ H} {d}_{c} ( {v}_{i} ) \cdot {x}_{i , j} \leq {c}_{j} \qquad ( 1 )$$

$${\sum }_{i ϵ {V}_{s} , j ϵ H} {d}_{m} ( {v}_{i} ) \cdot {x}_{i , j} \leq {m}_{j} \qquad ( 2 )$$

Equation 3 specifies that a host hⱼ cannot be used as a candidate to host a VNF vᵢ if the tier of the host is the same as the restricted tier of the VNF vᵢ. In contrast, Equation 4 specifies that a host h must have the required VNF image viₙ of a VNF vₙ if the VNF vₙ is mapped to the host h.

$${tier}_{restriction} ( {v}_{i} ) \neq tier ( {h}_{j} ) , ∀ i ∈ {V}_{s} , j ∈ H \vert {x}_{i , j} = 1 \qquad ( 3 )$$

$${vi}_{n} ∈ {IM}_{h} , ∀ n ∈ {V}_{s} , h ∈ H \vert {x}_{n , h} = 1 \qquad ( 4 )$$

Regarding candidate path Pₛ used to connect the source, destination and candidate nodes of an SFC, Equation 5 defines that the sum of the delays of each link that composes the path should not exceed the maximum delay specified in the SLA of service s. Finally, Equation 6 defines the VNF coverage constraint, where each required VNF of a service must be mapped to a node.

$${\sum }_{l ∈ {P}_{s}} {d}_{l} \leq {d}_{s}^{max} \qquad ( 5 )$$

$${\sum }_{i ∈ {V}_{s}} {x}_{i , j} = 1 \qquad ( 6 )$$

An embodiment of performing federated distributed SFC segment placement will now be explained using the federated distributed system 100. FIG. 1B illustrates a simplified view of the federated edge computing system 100 shown in FIG. 1A and thus does not include the labels for the intra-domain links. In the embodiment of FIG. 1B, a user provides an SFC request 102 and its underlying SLA to the domain 110 that specifies the number of VNFs that will be needed to complete the SFC. For ease of explanation and illustration, in the embodiment only the first four VNFs that are needed are illustrated, denoted by the numbers “1”, “2”, “3”, and “4”. However, there may be any number of additional VNFs needed to complete the SFC. The SFC request also specifies a source node, which in the embodiment is edge-tier node 112E of domain 110 and is denoted by “S”, from which the service packets (i.e., application workload) will arrive. The SFC request also specifies a destination node, where the SFC terminates, and the service is provided. In FIG. 1B, a destination node is shown at edge-tier node 112D of domain 110, which is denoted by “D”. Although the source and destination nodes are shown as being part of the same domain, this is for ease of explanation and illustration only and need not always be the case as in some embodiments the source and destination nodes may be in different domains.

Upon receipt of the SFC request 102, the domain 110 determines if its nodes are candidates for the VNFs specified in the SFC request 102. That is, the domain 110 determines if its candidate nodes are able to host the specified VNFs based on if they meet the constraints previously discussed such as tier restrictions, delay budgets, and available CPU and memory resources. In the embodiment, the domain 110 determines that cloud-tier node 114A can host VNF 1, edge-tier node 112A can host VNF 2, and cloud-tier node 114B can host VNF 4. However, there is no candidate node of domain 110 that meets the constraints to host VNF 3. Thus, the domain 110 will rely on the domain 120 and/or the domain 130 to host the VNF 3 as will be explained. It will be appreciated that although FIG. 1B shows the VNFs being hosted by only one node of domain 110, this is for ease of explanation only and in some embodiments there may be any number of nodes in domain 110 (and domains 120 and 130) that meet the constraints to host a given VNF.

As also illustrated in FIG. 1B, the domains 120 and 130 receive the SFC request 102 from the domain 110 and also determine if their nodes are candidates for the VNFs specified in the SFC request 102. FIG. 1B illustrates that edge-tier node 122B of domain 120 meets the constraints to host VNF 2, cloud-tier node 124A of domain 120 meets the constraints to host VNF 3, and edge-tier node 122A of domain 120 meets the constraints to host VNF 4. In addition, edge-tier node 132B of domain 130 meets the constraints to host VNF 2, cloud-tier node 134A of domain 130 meets the constraints to host VNF 3, and edge-tier node 132A of domain 130 also meets the constraints to host VNF 3.

While performing the federated distributed SFC segment placement process, each domain will attempt to find the longest contiguous segment of VNFs that can be mapped within the domain, i.e., the longest segment. To find this segment, each domain will start from a referenced starting node and VNF, which will be the first VNF to be allocated in the segment. First, the domain sets the start node as the previous node in relation to the current candidate node to be found for the current VNF, which will be the first node that will compose the segment. Then, the current VNF is marked as explored in the domain. After that, the domain must find a list of all candidate nodes that have (i) the required CPU and memory resources, (ii) the image to host the type of the current VNF, and (iii) the conditions to satisfy the tier constraints. Then, the domain calculates the shortest path between the previous node and the candidate node, checking if it violates the maximum delay specified at the SLA. If it does, then another candidate node will be selected. If not, then the domain will check if a neighbor domain can be reached within the maximum delay considering the mapping of the current VNF to the candidate node, since to be a valid candidate solution it must comply with the delay requirements. The only exception is if the domain is mapping the last VNF of the SFC and contains the destination node. In this case, the domain only needs to verify if the destination node can be reached within the maximum delay, considering the shortest path between the candidate node for the last VNF and the destination node.

If the delay of the path between the candidate node to at least one of the gateway nodes of the domain is below the SLA's maximum delay, the candidate node and the path are added to the segment solution tree. Since the domain is looking for the longest segment in terms of mapped VNFs, the domain also checks if the segment solution tree found so far is the longest one, storing it if it is the longest. Then, the current VNF is marked as explored and the same process occurs for the next VNF to be mapped in the SFC, but now considering the previously mapped candidate node as the previous node.

In case that a VNF cannot be mapped to any nodes in the current domain, then the domain takes a step back exploring other candidate nodes for the previous VNF in an attempt to find another mapping that leads to a longer contiguous chain of mapped VNFs. The process stops when all VNFs are mapped or if the domain has exhausted all candidate nodes for the first current VNF that was passed as an input, returning the longest stored segment solution tree.

FIG. 1C shows this process performed by domain 110 in the current embodiment. As illustrated in FIG. 1C, the domain 110 places the source edge-tier node 112E as the start of a segment solution tree 104. The domain 110 then tries to find the longest contiguous segment of ordered VNFs that can be mapped within the domain while meeting the constraints previously discussed. In the current embodiment, the domain 110 maps a segment that includes a path 152 that has a latency of 4 between the source edge-tier node 112E and cloud-tier node 114A hosting VNF 1 and a path 154 that has a latency of 4 between cloud-tier node 114A hosting VNF 1 and edge-tier node 112A hosting VNF 2 as the longest contiguous segment since the domain 110 cannot host the VNF 3. In addition, since the domain 110 cannot host VNF 3, the domain 110 will map a path to domain 120 and a path to domain 130 for access to VNF 3 that may be hosted at one or both of these domains.

Thus, the domain 110 maps a path 156 having a latency of 2 between edge-tier node 112A hosting VNF 2 and gateway edge-tier node 116, also denoted as 110 to identify it as a gateway node for domain 110, and maps the inter-domain link 142 having a latency of 2 between the gateway edge-tier node 116 and the gateway edge-tier node 126 of domain 120, also denoted as 120 to identify it as a gateway node for domain 120, as a first branch of the segment solution tree 104. The domain 110 also maps a path 158 having a latency of 3 between edge-tier node 112A hosting VNF 2 and gateway edge-tier node 118, also denoted as 110 to identify it as a gateway node for domain 110, and maps the inter-domain link 144 having a latency of 3 between the gateway edge-tier node 118 and the gateway edge-tier node 138 of domain 130, also denoted as 130 to identify it as a gateway node for domain 130, as a second branch of the segment solution tree 104. Thus, the segment solution tree 104 includes a segment including the paths 152, 154, 156, and 142 and a segment including the paths 152, 154, 158, and 144.

While performing the federated distributed SFC segment placement process, the domain 110 also performs backward analysis, which is an approach to increase the number of possible solutions during the multi-domain segment placement. Thus, the purpose of backward analysis is to provide alternative paths for candidate nodes that the domain 110 considers when mapping VNFs into the segment solution tree 104 so that other domains can also make decisions based on these alternative solutions. This approach prevents the placement decision being based on a single solution that could ended up as unfeasible depending on how the various domains map their candidate nodes and paths, leading to a placement failure. It also allows the destination domain to choose the solution with the lowest cost in terms of latency and resource allocation, when multiple solutions are available in the final segment solutions tree 104.

For example, FIG. 1D shows an example embodiment of backward analysis. Since the domain 120 may be able to host VNF 2, VNF3, and/or VNF 4, domain 110 maps a segment including the previously mapped path 152 that has a latency of 4 between the source edge-tier node 112E and cloud-tier node 114A hosting VNF 1 and maps a path 153 having a latency of 1 between cloud-tier node 114A hosting VNF 1 and gateway edge-tier node 116 and maps the inter-domain link 142 having a latency of 2 between gateway edge-tier node 116 and gateway edge-tier node 126 of domain 120.

Likewise, FIG. 1E shows an example embodiment of backward analysis. Since the domain 130 may be able to host VNF 2, VNF3, and/or VNF 4, domain 110 maps a segment including the previously mapped path 152 that has a latency of 4 between the source edge-tier node 112E and cloud-tier node 114A hosting VNF 1 and maps a path 155 having a latency of 4 between cloud-tier node 114A hosting VNF 1 and gateway edge-tier node 118 and maps the inter-domain link 144 having a latency of 2 between gateway edge-tier node 118 and gateway edge-tier node 138 of domain 130.

While performing the federated distributed SFC segment placement process, the domain 110 also performs forward planning, which is an approach for domain 110 to find multiple segments of contiguous VNFs before sending the segment solution tree 104 to the other domains. When domain 110 cannot find a segment mapping all VNFs, it will first try to find the segment with the longest number of contiguous VNF, skip the VNFs that cannot be mapped and try to find other segments within the domain, considering the rest of the VNFs to be mapped. The idea is that another available domain trying to map the skipped VNFs can know in advance how its segment can be combined with the segments previously found by domain 110.

For example, FIG. 1F shows an example embodiment of forward planning. Since domain 110 is able to host up to VNF 2 and expects that that domain 120 is able to host VNF 3, domain 110 maps a segment including the inter-domain link 142 having a latency of 2 between the gateway edge-tier node 126 of domain 120 and gateway edge-tier node 116, a path 157 having a latency of 3 between gateway edge-tier node 116 and cloud-tier node 114B hosting VNF 4, and a path 151 having a latency of 4 between cloud-tier node 114B hosting VNF 4 and destination edge-tier node 112D. In this way, domain 120 will be informed of a possible path from VNF 3 to the destination edge-tier node 112D when domain 120 updates the segment solution tree 104 as will be explained in more detail to follow.

Likewise, FIG. 1G shows another example embodiment of forward planning. Since domain 110 is able to host up to VNF 2 and expects that that domain 130 is able to host VNF 3, domain 110 maps a segment including the inter-domain link 144 having a latency of 3 between the gateway edge-tier node 138 of domain 130 and gateway edge-tier node 118, a path 159 having a latency of 2 between gateway edge-tier node 118 and cloud-tier node 114B hosting VNF 4, and the path 151 having a latency of 4 between cloud-tier node 114B hosting VNF 4 and destination edge-tier node 112D. In this way, domain 130 will be informed of a possible path from VNF 3 to the destination edge-tier node 112D when domain 130 updates the segment solution tree 104.

After performing backward analysis and forward planning, the domain 110 maps the resulting segments onto an updated segment solution tree 104 shown in FIG. 1H. Thus, the segment solution tree 104 of FIG. 1H includes the possible solution including the longest segment including the paths 152, 154, 156, and 142 or the paths 152, 154, 158, and 144. In addition, the updated segment solution tree 104 includes the segments including the paths 153 and 142 and the paths 155 and 154 that were mapped during the backward analysis process. Further, the updated segment solution tree 104 includes the segments found during the forward planning process and added to the longest segments that provide guidance in advance to the domains 120 and 130 how their segments can be combined with the segments of domain 110.

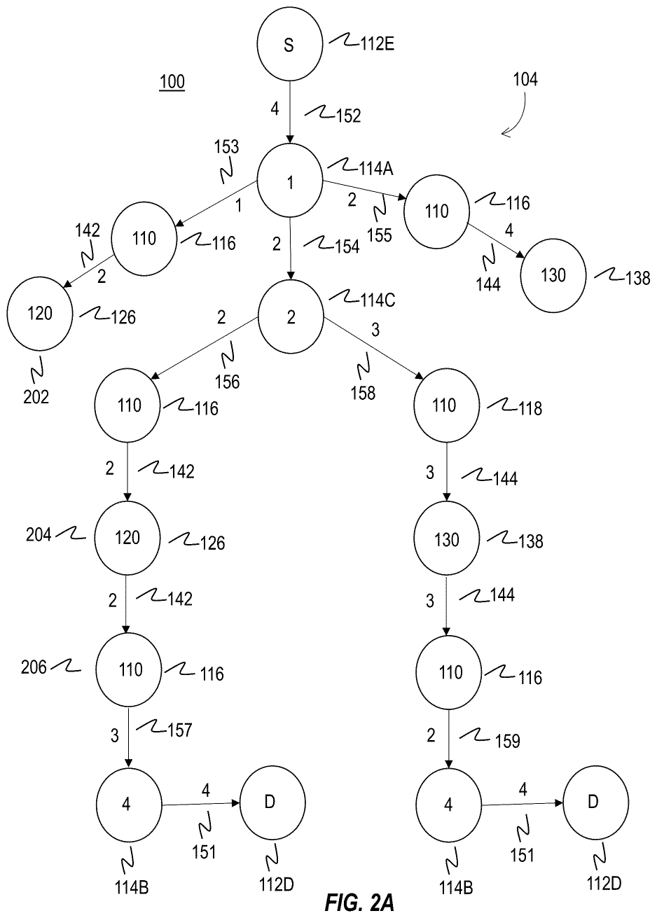

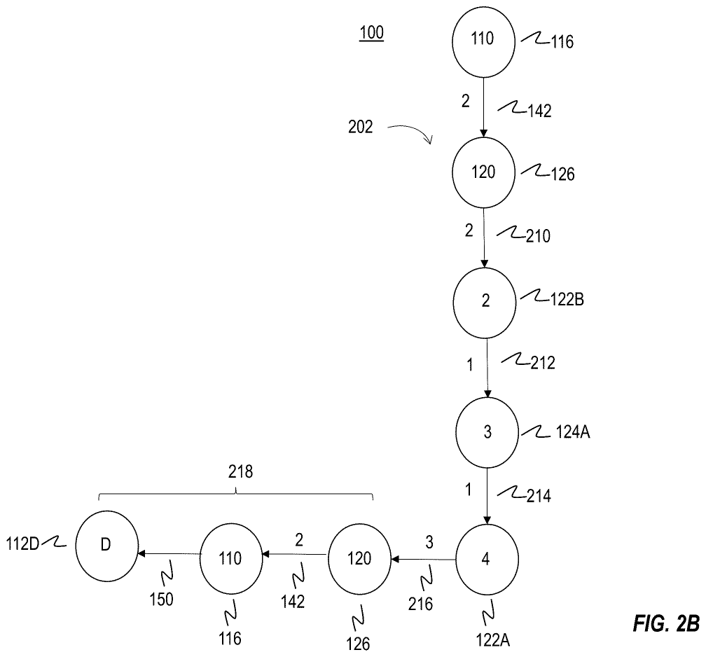

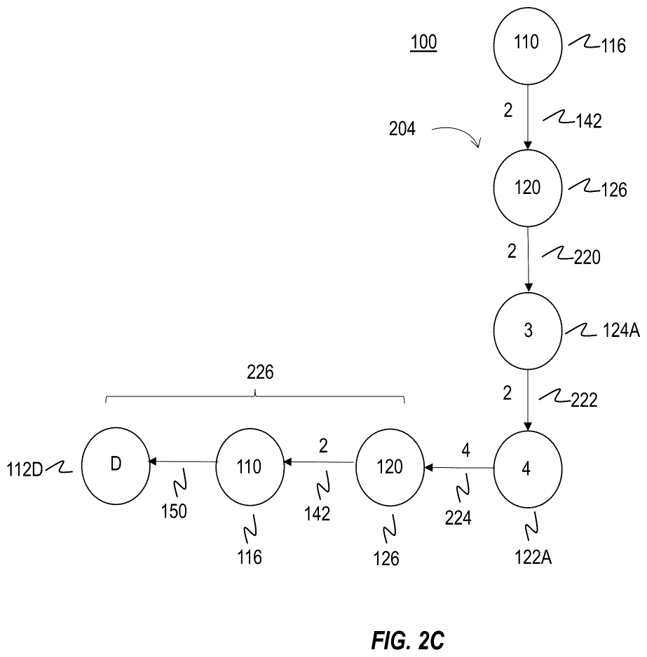

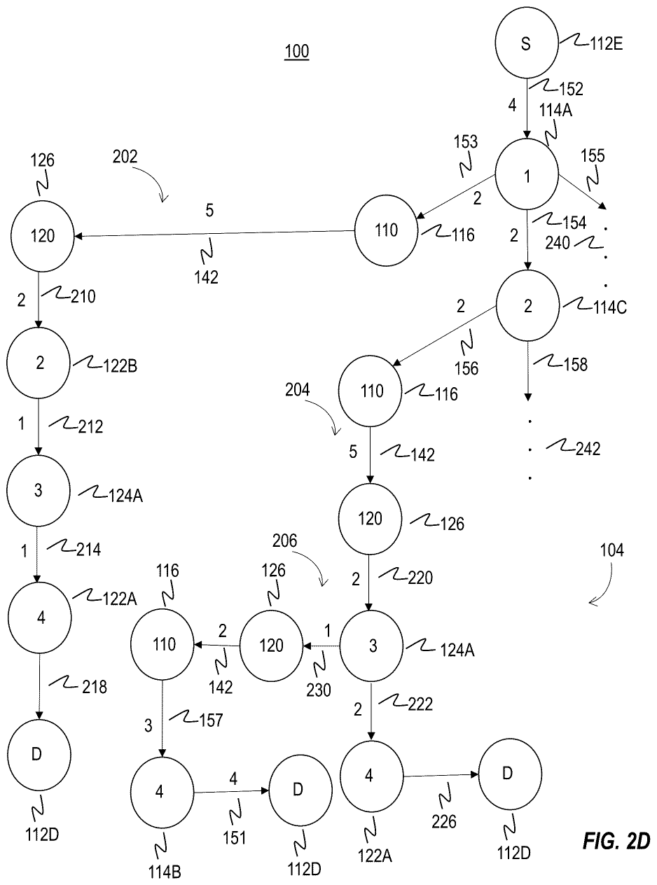

As mentioned previously, once the domain 110 has included all the possible segments including the VNFs it can host into the segment solution tree 104, the domain 110 sends the segment solution tree 104 to domains 120 and 130 so that these domains may then map their nodes into the solution tree. FIG. 2A illustrates an embodiment of the segment solution tree 104 that is sent to the domain 120 via the inter-domain link 142 and to the domain 130 via the inter-domain link 144. Accordingly, the segment solution tree 104 of FIG. 2A is the same as the segment solution tree 104 of FIG. 1H.

FIG. 2A illustrates a point 202, a point 204, and a point 206. The points 202 and 204 are points in the segment solution tree 104 that include the edge-tier node 126 of domain 120 and represent that the domain 120 will be providing hosts for some of the VNFs specified in the SFC request 102. In other words, the points 202 and 204 are closest to the source edge-tier node 112E, which is the root node of the segment solution tree 104. However, as mentioned previously, for privacy reasons that domain 110 does not know which actual nodes of the domain 120 will host the VNFs. Thus, the domain 120 will map the actual nodes onto the segment solution tree 104 at points 202 and 204 as will be explained in more detail to follow. The point 206 will also be explained in more detail to follow.

FIG. 2B illustrates the process of the domain 120 mapping its nodes onto the segment solution tree 104 at point 202. As illustrated, at point 202 the SFC already includes VNF 1 and so needs the VNFs 2, 3, and 4 to complete the VNF chain of the SFC. Thus, at point 202 the domain 120 maps a segment including a path 210 having a latency of 2 between gateway edge-tier node 126 and edge-tier node 122B hosting VNF 2, a path 212 having a latency of 1 between edge-tier node 122B hosting VNF 2 and cloud-tier node 124A hosting VNF 3, a path 214 having a latency of 1 between cloud-tier node 124A hosting VNF 3 and edge-tier node 122A hosting VNF 4, a path 216 having a latency of 3 between edge-tier node 122A hosting VNF 4 and gateway edge-tier node 126, and the inter-domain link 142 having a latency of 2 between the gateway edge-tier node 126 and gateway edge-tier node 116 of domain 110. Thus, the segment including the paths 210, 212, 214, 216, and 142 would constitute the longest contiguous segment between the VNFs.

Although it would not directly map a path 150 from the gateway edge-tier node 116 of domain 110 to the destination edge-tier node 112D as this would be done by the domain 110, the path 150 is included in FIG. 2B for ease of explanation since the domain 120 would know of the destination edge-tier node 112D from the received segment solution tree 104. The paths 216, 142, and 150 are denoted by 218 for ease of illustration in FIG. 2D.

FIG. 2C illustrates the process of the domain 120 mapping its nodes onto the segment solution tree 104 at point 204. As illustrated, at point 204 the SFC already includes VNFs 1 and 2 and so needs the VNFs 3 and 4 to complete the VNF chain of the SFC. Thus, at point 204 the domain 120 maps a segment including a path 220 having a latency of 2 between gateway edge-tier node 126 and cloud-tier node 124A hosting VNF 3, a path 222 having a latency of 2 between cloud-tier node 124A hosting VNF 3 and edge-tier node 122A hosting VNF 4, a path 224 having a latency of 4 between edge-tier node 122A hosting VNF 4 and gateway edge-tier node 126, and the inter-domain link 142 having a latency of 2 between the gateway edge-tier node 126 and gateway edge-tier node 116 of domain 110. Although it would not directly map the path 150 from the gateway edge-tier node 116 of domain 110 to the destination edge-tier node 112D as this would be done by the domain 110, the path 150 is included in FIG. 2C for ease of explanation since the domain 120 would know of the destination edge-tier node 112D from the received segment solution tree 104. The paths 224, 142, and 150 are denoted by 226 for ease of illustration in FIG. 2D.

FIG. 2D illustrates an updated segment solution tree 104 that includes the segments mapped at points 202 and 204. In addition, as shown in FIG. 2D, the segment mapped at point 204 replaced the segment including the paths 142, 157, and 151 shown at point 206. However, the segment at point 206 would still be a valid possible SFC segment placement solution. Accordingly, as further shown in FIG. 2D the domain 120 combines the segment replaced at point 206 with a portion of the segment mapped at point 204 into the updated segment solution tree 104. Specifically, the domain 120 maps a segment including a path 230 have a latency of 1 that is between cloud-tier node 124A hosting VNF 3 and the edge-tier gateway node 126 and the paths 142, 157, and 151. Although not illustrated, the paths 142, 157, and 151 shown at point 206 can also be combined into a segment with the with a portion of the segment mapped at point 202 by replacing path 214 with the paths of point 206. In some embodiments, however, domain 120 may assign VNF 3 to edge-tier node 122D and a different segment would be mapped. Thus, the updated segment solution tree 104 of FIG. 2D includes a placement plan including the paths 152, 153, 142, 210, 212, 214, and 218, where the placement plan includes a first segment including the paths 152, 153, and 142, a second segment including paths 210, 212, 218, and a third segment including path 218 including the edge-tier gateway nodes that reach the destination edge-tier node 112D. The updated segment solution tree 104 of FIG. 2D also includes a placement plan including the paths 152, 154, 156, 142, 220, 222, and 226, a segment including the paths 152, 154, 156, 142, 220, 230, 142, 157, and 151, and a placement plan (not illustrated) including the paths 152, 153, 142, 210, 212, and the paths of point 206.

For ease of explanation, only the mappings performed by domain 120 upon receiving the segment solution tree 104 have been described. However, it will be appreciated that a similar mapping process would also be performed by the domain 130 upon receiving the segment solution tree 104 and the segment solution tree would be updated with such mapping as illustrated by the ellipses 240 and 242 in FIG. 2D. Further, for ease of explanation, the embodiments disclosed herein only showed the interaction of the domain 110 and 120 or 110 and 130 in updating the segment solution tree 104. However, in some embodiments the segment solution tree 104 can be sent from the domain 110 to the domain 120 and from the domain 120 to the domain 130 or from the domain 110 to the domain 130 and from the domain 130 to the domain 120 for mapping possible segment placements.

Once the domains 120 and/or 130 have completed their updating of the segment solution tree 104, the segment solution tree is returned to the domain 110 since the domain 110 includes the destination edge-tier node 112D. Of course, if the destination node were in one of the domains 120 or 130, then the updated segment solution tree 104 would be returned to that domain. In some embodiments, the domains 120 and 130 return separate segment solution trees and these are combined by the domain 110 into a final segment solution tree 104.

The domain 110 will then use the final segment solution tree 104 to choose the segment having the placement plan with the least cost. That is, since each segment only includes nodes that satisfy the constraints previously described to be able to host a VNF and since each segment shows the overall latency or delay, the domain 110 is able to select the segments that comprise the placement plan that will most cost efficiently implement the VNFs of the SFC while satisfying service requirements specified in the SLA associated with the SFC request 102. In other words, the domain 110 will select the segment that uses the least amount of computing system resources such as CPU and memory and that has the smallest latency or delay while also the other service requirements specified in the SLA associated with the SFC request 102.

It will be appreciated that any of the actions described herein as being performed by domain 110 can also be performed by domains 120 and 130. That is, domains 120 and 130 may also perform the forward planning and backward analysis described herein as they update the segment solution tree. Likewise, domains 110 and 130 can also combine segments as described herein in relation to domain 120 as they update the segment solution tree.

Accordingly, the embodiments disclosed herein consider SFC placement based on a heterogeneous, distributed and multi-domain environment. Therefore, the embodiments disclosed herein consider that each node and link will have a specific amount of available resources that varies as service are placed, which impact future placement decisions. The embodiments disclosed herein utilize a decentralized mechanism to break down the problem of SFC placement, where multiple domains can participate in the placement decision-making. The embodiments disclosed herein also address how to exchange partial placement solutions between domains to find multiple feasible placement solutions and allow the convergence of the distributed approach to a final placement decision.

The embodiments disclosed herein, different from a solution in which the SFC is viewed as an atomic entity, (i.e., indivisible), consider that SFCs can be broken into multiple segments. Thus, the embodiments disclosed herein utilize a mechanism where each segment will be generated based on the candidate nodes and links selected by each domain, based on their own resource capacities and policies. At the same time, the embodiments disclosed herein are able to form complete solutions for requested services, by employing resource allocation and delay constraints to be followed by each collaborating domain. In addition, the embodiments disclosed herein provide mechanisms to increase the number of different segmentation possibilities. This characteristic allows for the generation of multiple feasible solutions and allows for the choice of the one that is the most suitable.

Privacy preserving can be a major concern in multi-domain environments since domains might not be willing to disclosure their internal information to other domains. In the embodiments disclosed herein, a mechanism is utilized that finds feasible placement solutions without the need to share intra-domain, sensible resource information. In the embodiments disclosed herein, only the identity of gateways nodes and the capacity of inter-domain links is required, so that each domain knows how to reach neighboring domains and if the inter-domain link will have the required bandwidth to be part of the placement solution. Domains will know if another domain can or cannot place a VNF and the delay between VNF placements, but internal information is preserved. Also, because the VNF placement decisions are made individually, each domain retains their autonomy to choose the candidate nodes that they consider appropriate, based on their own policies and resource availability.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

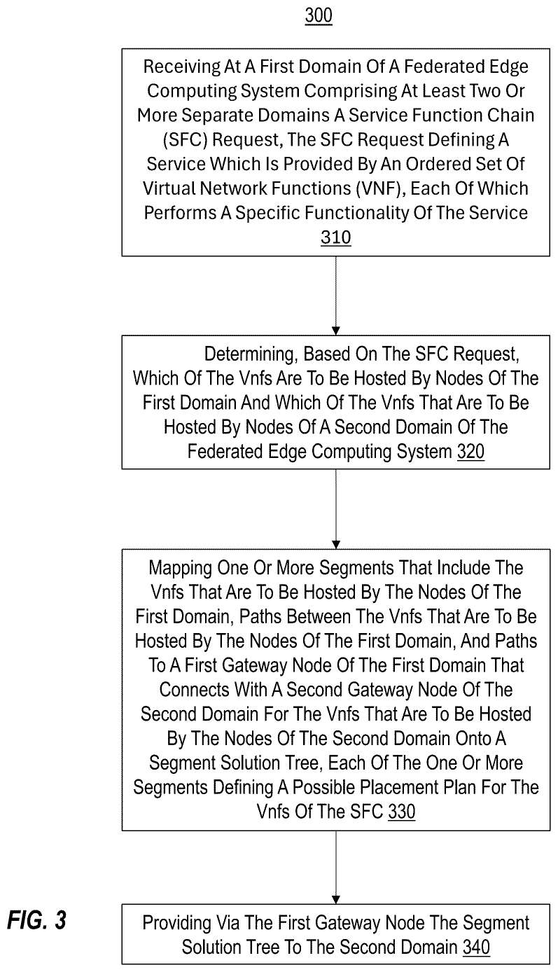

Directing attention now to FIG. 3, an example method 300 according to some embodiments is disclosed. The method 300 will be discussed with reference to one or more of the figures previously described, although the method 300 is not limited to any particular embodiment.

The method 300 includes receiving at a first domain of a federated edge computing system comprising at least two or more separate domains a Service Function Chain (SFC) request, the SFC request defining a service which is provided by an ordered set of Virtual Network Functions (VNF), each of which performs a specific functionality of the service (310). For example, as previously described the domain 110 receives the SFC request 102. The domains 110, 120, and 130 are part of the federated edge computing system 100.

The method 300 includes determining, based on the SFC request, which of the VNFs are to be hosted by nodes of the first domain and which of the VNFs that are to be hosted by nodes of a second domain of the federated edge computing system (320). For example, as previously described the domain 110 determines that its nodes can host the VNFs 1, 2, and 4, but cannot host the VNF 3. The domains 120 and/or 130 are able to host the VNF 3.

The method 300 mapping one or more segments that include the VNFs that are to be hosted by the nodes of the first domain, paths between the VNFs that are to be hosted by the nodes of the first domain, and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC (330). For example, as previously described, in particular with reference to FIGS. 1C-1H, the domain 110 maps the segments including the nodes hosting the VNFs and paths between the nodes onto the segment solution tree 104.

The method 300 includes providing via the first gateway node the segment solution tree to the second domain (340). For example, as previously described the domain 110 provides the segment solution tree 104 to the domains 120 and 130.

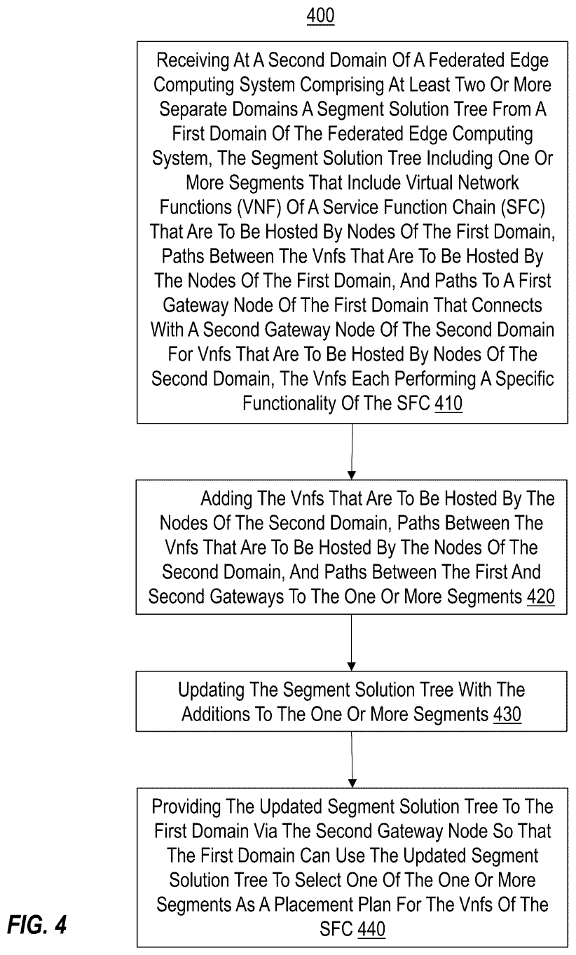

Directing attention now to FIG. 4, an example method 400 according to some embodiments is disclosed. The method 400 will be discussed with reference to one or more of the figures previously described, although the method 400 is not limited to any particular embodiment.

The method 400 includes receiving at a second domain of a federated edge computing system comprising at least two or more separate domains a segment solution tree from a first domain of the federated edge computing system, the segment solution tree including one or more segments that include Virtual Network Functions (VNF) of a Service Function Chain (SFC) that are to be hosted by nodes of the first domain, paths between the VNFs that are to be hosted by the nodes of the first domain, and paths to a first gateway node of the first domain that connects with a second gateway node of the second domain for VNFs that are to be hosted by nodes of the second domain, the VNFs each performing a specific functionality of the SFC (410). For example, as previously described the domain 120 receives the segment solution tree 104. The segment solution tree 104 includes the segments including the nodes hosting the VNFs and paths between the nodes of the domain 110.

The method 400 includes adding the VNFs that are to be hosted by the nodes of the second domain, paths between the VNFs that are to be hosted by the nodes of the second domain, and paths between the first and second gateways to the one or more segments (420). For example, as previously described, in particular with reference to FIGS. 2A-2D, the domain 120 adds nodes hosting the VNFs and paths between the nodes of the second domain 120 so that these nodes and paths become part of the segments already existing in the segment solution tree 104.

The method 400 includes updating the segment solution tree with the additions to the one or more segments (430). For example, as previously described the domain 120 updates the segment solution tree 104.

The method 400 includes providing the updated segment solution tree to the first domain via the second gateway node so that the first domain can use the updated segment solution tree to select one of the one or more segments as a placement plan for the VNFs of the SFC (440). For example, as previously described the domain 120 provides the updated segment solution tree 104 to the domain 110 so the domain 110, which includes the destination edge-tier node 112D, can select a segment as a placement plan for the VNFs of the SFC.

### E. Further Example Embodiments

Following are some further example embodiments. These are presented only by way of example and are not intended to limit the scope of this disclosure or the claims in any way.

Embodiment 1. A method, comprising: receiving at a first domain of a federated edge computing system comprising at least two or more separate domains a Service Function Chain (SFC) request, the SFC request defining a service which is provided by an ordered set of Virtual Network Functions (VNF), each of which performs a specific functionality of the service; determining, based on the SFC request, which of the VNFs are to be hosted by nodes of the first domain and which of the VNFs that are to be hosted by nodes of a second domain of the federated edge computing system; mapping one or more segments that include the VNFs that are to be hosted by the nodes of the first domain, paths between the VNFs that are to be hosted by the nodes of the first domain, and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC; and providing via the first gateway node the segment solution tree to the second domain.

Embodiment 2. The method of embodiments 1, further comprising: receiving the segment solution tree back from the second domain, the segment solution tree received back from the second domain including the VNFs that are to be hosted by the nodes of the second domain, paths between the VNFs that are to be hosted by the nodes of the second domain, and paths between the first and second gateways that have been added to the one or more segments by the second domain; and selecting one of the one or more segments as the placement plan for the VNFs of the SFC.

Embodiment 3. The method of embodiments 1-2, wherein the selected one of the one or more segments is a segment that uses the least amount of computing system resources and has the smallest delay.

Embodiment 4. The method of embodiments 1-3, wherein mapping the one or more segments onto the segment solution tree comprises: mapping the longest, contiguous segment of VNFs hosted by nodes of the first domain.

Embodiment 5. The method of embodiments 1-4, wherein mapping the one or more segments onto the segment solution tree comprises: performing a forward planning process that maps paths between a VNF hosted by a node of the first domain that is not contiguous with any other VNFs hosted by nodes of the first domain and the first gateway node onto the segment solution tree prior to the segment solution tree being sent to the second domain.

Embodiment 6. The method of embodiments 1-5, wherein mapping the one or more segments onto the segment solution tree comprises: performing a backward analysis process that determines additional segments to map onto the segment solution tree after the one or more segments have been mapped onto the segment solution tree and prior to the segment solution tree being sent to the second domain.

Embodiment 7. The method of embodiments 1-6, wherein the one or more segments include a source node as a first node of the SFC where service packets of the SFC are received and a destination node as a final node of the SFC, the VNFs being between the source and destination nodes in the one or more segments.

Embodiment 8. The method of embodiments 1-7, wherein the VNFs are to be hosted by nodes of the first domain that comply with computing system resource constraints and service level constraints.

Embodiment 9. A method, comprising: receiving at a second domain of a federated edge computing system comprising at least two or more separate domains a segment solution tree from a first domain of the federated edge computing system, the segment solution tree including one or more segments that include Virtual Network Functions (VNF) of a Service Function Chain (SFC) that are to be hosted by nodes of the first domain, paths between the VNFs that are to be hosted by the nodes of the first domain, and paths to a first gateway node of the first domain that connects with a second gateway node of the second domain for VNFs that are to be hosted by nodes of the second domain, the VNFs each performing a specific functionality of the SFC; adding the VNFs that are to be hosted by the nodes of the second domain, paths between the VNFs that are to be hosted by the nodes of the second domain, and paths between the first and second gateways to the one or more segments; updating the segment solution tree with the additions to the one or more segments; and providing the updated segment solution tree to the first domain via the second gateway node so that the first domain can use the updated segment solution tree to select one of the one or more segments as a placement plan for the VNFs of the SFC.

Embodiment 10. The method of embodiment 9, wherein adding paths to the one or more segments onto comprises: mapping the longest contiguous segment of VNFs hosted by nodes of the second domain onto the updated segment solution tree.

Embodiment 11. The method of embodiments 9-10, wherein adding paths to the one or more segments onto comprises: combining portions of two segments into a single segment; and mapping the single segment onto the updated segment solution tree.

Embodiment 12. The method of embodiments 9-11, wherein the identity of the nodes of the second domain that are host the VNFs are not known by the first domain prior to the second domain updating the segment solution tree.

Embodiment 13. The method of embodiments 9-12, wherein the VNFs are to be hosted by nodes of the second domain that comply with computing system resource constraints and service level constraints.

Embodiment 14. A non-transitory storage medium having stored therein instructions that are executable by one or more hardware processors to perform operations comprising: receiving at a first domain of a federated edge computing system comprising at least two or more separate domains a Service Function Chain (SFC) request, the SFC request defining a service which is provided by an ordered set of Virtual Network Functions (VNF), each of which performs a specific functionality of the service; determining, based on the SFC request, which of the VNFs are to be hosted by nodes of the first domain and which of the VNFs that are to be hosted by nodes of a second domain of the federated edge computing system; mapping one or more segments that include paths between the VNFs that are to be hosted by the nodes of the first domain and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC; and providing via the gateway node the segment solution tree to the second domain.

Embodiment 15. The non-transitory storage medium of embodiment 14, further comprising: receiving the segment solution tree back from the second domain, the segment solution tree received back from the second domain including paths between the VNFs that are to be hosted by the nodes of the second domain and paths between the first and second gateways that have been added to the one or more segments by the second domain; and selecting one of the one or more segments as the placement plan for the placement plan for the VNFs of the SFC.

Embodiment 16. The non-transitory storage medium of embodiments 14-15, wherein the selected one of the one or more segments is a segment that uses the least amount of computing system resources and has the smallest delay.

Embodiment 17. The non-transitory storage medium of embodiments 14-16, wherein mapping the one or more segments onto the segment solution tree comprises: mapping the longest, contiguous segment of VNFs hosted by nodes of the first domain.

Embodiment 18. The non-transitory storage medium of embodiments 14-17, wherein mapping the one or more segments onto the segment solution tree comprises: performing a forward planning process that maps paths between a VNF hosted by a node of the first domain that is not contiguous with any other VNFs hosted by nodes of the first domain and the first gateway node onto the segment solution tree prior to the segment solution tree being sent to the second domain.

Embodiment 19. The non-transitory storage medium of embodiments 14-18, wherein mapping the one or more segments onto the segment solution tree comprises: performing a backward analysis process that determines additional segments to map onto the segment solution tree after the one or more segments have been mapped onto the segment solution tree and prior to the segment solution tree being sent to the second domain.

Embodiment 20. The non-transitory storage medium of embodiments 14-19, wherein the one or more segments include a source node as a first node of the SFC where service packets of the SFC are received and a destination node as a final node of the SFC, the VNFs being between the source and destination nodes in the one or more segments.

A system, comprising hardware and/or software, operable to perform any of the operations, methods, or processes, or any portion of any of these, disclosed herein.

A non-transitory storage medium having stored therein instructions that are executable by one or more hardware processors to perform operations comprising the operations of any one or more of embodiments 9-13.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

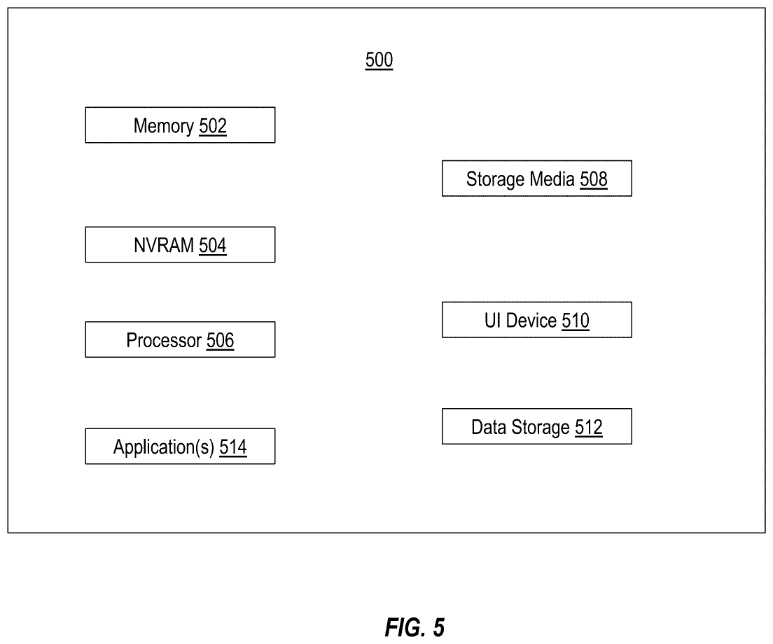

With reference briefly now to FIG. 5, any one or more of the entities disclosed, or implied, by any figure discussed herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving at a first domain of a federated edge computing system comprising at least two or more separate domains a Service Function Chain (SFC) request, the SFC request defining a service which is provided by an ordered set of Virtual Network Functions (VNFs), each of which performs a specific functionality of the service;
determining, based on the SFC request, which of the VNFs are to be hosted by nodes of the first domain and which of the VNFs are to be hosted by nodes of a second domain of the federated edge computing system;
mapping one or more segments that include the VNFs that are to be hosted by the nodes of the first domain, paths between the VNFs that are to be hosted by the nodes of the first domain, and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC; and
providing via the first gateway node the segment solution tree to the second domain.

2. The method of claim 1, further comprising:
receiving the segment solution tree back from the second domain, the segment solution tree received back from the second domain including the VNFs that are to be hosted by the nodes of the second domain, paths between the VNFs that are to be hosted by the nodes of the second domain, and paths between the first and second gateways that have been added to the one or more segments by the second domain; and
selecting one of the one or more segments as the placement plan for the VNFs of the SFC.

3. The method of claim 2, wherein the selected one of the one or more segments is a segment that uses a least amount of computing system resources and has a smallest delay.

4. The method of claim 1, wherein mapping the one or more segments onto the segment solution tree comprises:
mapping a longest, contiguous segment of VNFs hosted by nodes of the first domain.

5. The method of claim 1, wherein mapping the one or more segments onto the segment solution tree comprises:
performing a forward planning process that maps paths between a VNF hosted by a node of the first domain that is not contiguous with any other VNFs hosted by nodes of the first domain and the first gateway node onto the segment solution tree prior to the segment solution tree being sent to the second domain.

6. The method of claim 1, wherein mapping the one or more segments onto the segment solution tree comprises:
performing a backward analysis process that determines additional segments to map onto the segment solution tree after the one or more segments have been mapped onto the segment solution tree and prior to the segment solution tree being sent to the second domain.

7. The method of claim 1, wherein the one or more segments include a source node as a first node of the SFC where service packets of the SFC are received and a destination node as a final node of the SFC, the VNFs being between the source and destination nodes in the one or more segments.

8. The method of claim 1, wherein the VNFs are to be hosted by nodes of the first domain that comply with computing system resource constraints and service level constraints.

9. A method, comprising:
receiving at a second domain of a federated edge computing system comprising at least two or more separate domains a segment solution tree from a first domain of the federated edge computing system, the segment solution tree including one or more segments that include Virtual Network Functions (VNFs) of a Service Function Chain (SFC) that are to be hosted by nodes of the first domain, paths between the VNFs that are to be hosted by the nodes of the first domain, and paths to a first gateway node of the first domain that connects with a second gateway node of the second domain for VNFs that are to be hosted by nodes of the second domain, the VNFs each performing a specific functionality of the SFC;
adding the VNFs that are to be hosted by the nodes of the second domain, paths between the VNFs that are to be hosted by the nodes of the second domain, and paths between the first and second gateways to the one or more segments;
updating the segment solution tree with the additions to the one or more segments; and
providing the updated segment solution tree to the first domain via the second gateway node so that the first domain can use the updated segment solution tree to select one of the one or more segments as a placement plan for the VNFs of the SFC.

10. The method of claim 9, wherein adding paths to the one or more segments onto comprises:
mapping a longest contiguous segment of VNFs hosted by nodes of the second domain onto the updated segment solution tree.

11. The method of claim 9, wherein adding paths to the one or more segments onto comprises:
combining portions of two segments into a single segment; and
mapping the single segment onto the updated segment solution tree.

12. The method of claim 9, wherein an identity of the nodes of the second domain that are host the VNFs are not known by the first domain prior to the second domain updating the segment solution tree.

13. The method of claim 9, wherein the VNFs are to be hosted by nodes of the second domain that comply with computing system resource constraints and service level constraints.

14. A non-transitory storage medium having stored therein instructions that are executable by one or more hardware processors to perform operations comprising:
receiving at a first domain of a federated edge computing system comprising at least two or more separate domains a Service Function Chain (SFC) request, the SFC request defining a service which is provided by an ordered set of Virtual Network Functions (VNFs), each of which performs a specific functionality of the service;
determining, based on the SFC request, which of the VNFs are to be hosted by nodes of the first domain and which of the VNFs are to be hosted by nodes of a second domain of the federated edge computing system;
mapping one or more segments that include paths between the VNFs that are to be hosted by the nodes of the first domain and paths to a first gateway node of the first domain that connects with a second gateway node of the second domain for the VNFs that are to be hosted by the nodes of the second domain onto a segment solution tree, each of the one or more segments defining a possible placement plan for the VNFs of the SFC; and
providing via the gateway node the segment solution tree to the second domain.

15. The non-transitory storage medium of claim 14, further comprising:
receiving the segment solution tree back from the second domain, the segment solution tree received back from the second domain including paths between the VNFs that are to be hosted by the nodes of the second domain and paths between the first and second gateways that have been added to the one or more segments by the second domain; and
selecting one of the one or more segments as the placement plan for the placement plan for the VNFs of the SFC.

16. The non-transitory storage medium of claim 15, wherein the selected one of the one or more segments is a segment that uses a least amount of computing system resources and has a smallest delay.

17. The non-transitory storage medium of claim 14, wherein mapping the one or more segments onto the segment solution tree comprises:
mapping a longest, contiguous segment of VNFs hosted by nodes of the first domain.

18. The non-transitory storage medium of claim 14, wherein mapping the one or more segments onto the segment solution tree comprises:
performing a forward planning process that maps paths between a VNF hosted by a node of the first domain that is not contiguous with any other VNFs hosted by nodes of the first domain and the first gateway node onto the segment solution tree prior to the segment solution tree being sent to the second domain.

19. The non-transitory storage medium of claim 14, wherein mapping the one or more segments onto the segment solution tree comprises:
performing a backward analysis process that determines additional segments to map onto the segment solution tree after the one or more segments have been mapped onto the segment solution tree and prior to the segment solution tree being sent to the second domain.

20. The non-transitory storage medium of claim 14, wherein the one or more segments include a source node as a first node of the SFC where service packets of the SFC are received and a destination node as a final node of the SFC, the VNFs being between the source and destination nodes in the one or more segments.
